(19) United States
(12) Patent Application Publication
(10) Pub. No.: US 2026/0117744 A1
(43) Pub. Date: Apr. 30, 2026

(54) MOUNTING ARRANGEMENT FOR A WIND TURBINE

(71) Applicants: ZF FRIEDRICHSHAFEN AG, Friedrichshafen (DE); ZF Wind Power Antwerpen N.V., Lommel (BE)

(72) Inventor: Arno Klein-Hitpass, Aachen (DE)

(21) Appl. No.: 19/359,767

(22) Filed: Oct. 16, 2025

(30) Foreign Application Priority Data
Oct. 30, 2024 (DE) 102024210472.8

(51) Int. Cl. F03D 13/10; F03D 80/70

(52) U.S. Cl. CPC F03D 13/122; F03D 80/70; F05B 2240/50; F05B 2240/912; F05B 2240/96; F05B 2260/4031

(57) ABSTRACT

A mounting arrangement for a wind turbine for supporting a drive train on a tower of the wind turbine is provided. The mounting arrangement includes a bedplate that is mounted on the tower. The mounting arrangement further includes a support housing and a coupling device. The support housing accommodates and supports the drive train. The coupling device includes a coupling element for converting a torsional moment about a torsional moment axis, which is applied by the drive train to the support housing, into a supporting force acting in a supporting direction. The coupling device further includes a bearing element for introducing the supporting force from the coupling element into the bedplate. The coupling device is configured to allow displacements of the support housing relative to the bedplate in a transverse direction perpendicular to the torsional moment axis and to the supporting direction.

### CROSS REFERENCE TO RELATED APPLICATIONS

This application claims benefit to German Patent Application No. DE 102024210 472.8, filed on October 30, 2024, which is hereby incorporated by reference herein.

### FIELD

The present disclosure relates to a mounting arrangement for a wind turbine. The present disclosure also relates to a wind turbine including a mounting arrangement.

### BACKGROUND

Wind turbines are known that serve to generate electricity from wind energy through conversion. For conversion, a rotor is provided in such plants, which is designed to convert wind energy into a mechanical power, for example, into a rotation with a torque. The torque generated in this way can be fed into a drive train in order to be converted into electrical power, for example by a generator. In view of the large weights and forces that occur, for example, in large wind turbines with an output of several megawatts, high demands are placed on the bearing of the drive train with regard to load capacity and vibration response.

### SUMMARY

In an embodiment, the present disclosure provides a mounting arrangement for a wind turbine for supporting a drive train on a tower of the wind turbine. The mounting arrangement includes a bedplate that is mounted on the tower. The mounting arrangement further includes a support housing for accommodating and supporting the drive train. The mounting arrangement further includes a coupling device that includes a coupling element for converting a torsional moment about a torsional moment axis, which is applied by the drive train to the support housing, into a supporting force acting in a supporting direction. The coupling device further includes a bearing element for introducing the supporting force from the coupling element into the bedplate. The coupling device is configured to allow displacements of the support housing relative to the bedplate in a transverse direction perpendicular to the torsional moment axis and to the supporting direction.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic illustration of a wind turbine with a drive train;

FIG. 2 is a schematic sectional front view illustrating a first embodiment of a mounting arrangement for the drive train of the wind turbine of FIG. 1;

FIG. 3 is a schematic sectional front view illustrating a second embodiment of a mounting arrangement for the drive train of the wind turbine of FIG. 1;

FIG. 4 is a schematic sectional front view illustrating a third embodiment of a mounting arrangement for the drive train of the wind turbine of FIG. 1; and

FIG. 5 is a schematic sectional front view illustrating a fourth embodiment of a mounting arrangement for the drive train of the wind turbine of FIG. 1.

### DETAILED DESCRIPTION

A first aspect of the present disclosure relates to a mounting arrangement for a wind turbine for mounting a drive train on a tower of the wind turbine. The wind turbine may have a rotor. The rotor may be configured to convert wind energy into rotational mechanical energy and introduce the same into the drive train. The wind turbine may have a tower and a nacelle accommodating and supporting at least portions of the drive train. The nacelle may be mounted on a top end of the tower. The nacelle may be rotatably mounted on the tower. The nacelle may be rotatable about a vertical yaw axis to perform a yaw movement of the nacelle relative to the tower. The wind turbine may have a yaw bearing to provide yaw movement. The yaw movement may be used to align the nacelle or the drive train in a horizontal plane relative to the wind, for example, in order to achieve a desired angle of attack to the wind direction. A bottom end of the tower may be anchored to a ground. Alternatively, the bottom end of the tower may be mounted on an offshore wind turbine platform.

The drive train may include a generator to convert wind energy into electrical energy. The rotor may be connected to the generator, for example, via a rotor shaft of the drive train. The rotor may have a plurality of rotor blades, for example three rotor blades. The drive train may include a hub via which the rotor is coupled to the rotor shaft. The hub may be configured to adjust an angle of attack of the rotor blades. The drive train may include a gearbox disposed in a torque flow between the rotor and the generator. The generator may be configured to use the rotation of the rotor shaft or the rotation of an output of the gearbox for power generation. The gearbox may be configured to convert a rotational speed of the rotor shaft into another, for example higher, rotational speed for driving the generator. The rotational speed of the rotor shaft during operation may be, for example, between 2 rpm and 30 rpm, for example between 5 rpm and 20 rpm. The rotational speed for driving the generator during operation may be, for example, between 500 rpm and 3000 rpm, for example between 900 rpm and 2000 rpm. An input of the gearbox may be mechanically operatively connected to the rotor, and the output of the gearbox may be mechanically operatively connected, for example, to the generator. The gearbox may be configured to transmit a torque from the rotor shaft to the generator. The torque at the input of the gearbox during operation may be between 500,000 Nm and 15,000,000 Nm, for example between 3,000,000 Nm and 10,000,000 Nm. The drive train may also include ancillary equipment. The ancillary equipment may be configured to control parameters of the remainder of the drive train and physical variables of the wind turbine. The ancillary equipment may include, for example, a heating system, a cooling system, an alignment system for the nacelle, an adjustment system for the hub, and/or converter systems such as inverters for the generated electrical energy.

The mounting arrangement may be configured to support at least some kinematic degrees of freedom of the drive train. The kinematic degrees of freedom may include three translations and three rotations. The mounting arrangement may be configured to support one, multiple, or all degrees of freedom of the drive train or of portions thereof. Depending on the design of the mounting arrangement, another mounting arrangement may be provided which locks remaining degrees of freedom and/or supports portions of the drive train that are not supported by the mounting arrangement. In principle, it may be necessary to hold fixed five of the six degrees of freedom of the rotor shaft in order to operate the wind turbine. A rotational degree of freedom of the rotor shaft can remain free during operation in order to allow rotation of the rotor shaft and the associated introduction of torque for energy generation. The rotation of the rotor shaft can produce a reaction moment in the generator. The reaction moment in the generator can be supported by the mounting arrangement. The drive train may also include a braking device capable of braking the rotation of the rotor shaft, for example in case of excessive wind or for maintenance work.

The mounting arrangement includes a bedplate that can be mounted on the tower. The bedplate may be rotatably mounted on the tower, for example directly on the tower or indirectly via a yaw bearing. The bedplate may be configured to provide attachment points for the mounting arrangement for the introduction of forces and/or moments. The attachment points may include rigid connections and/or articulated connections. The bedplate may be configured, for example, as an at least partially annular element. The bedplate may also be configured as a shell component.

The mounting arrangement includes a support housing for accommodating and supporting the drive train. The support housing may be configured to accommodate and support the entire drive train or only portions thereof. For example, the support housing may support only the gearbox, only the generator, or both the gearbox and the generator. The support housing may also be configured to support rotatable elements. The rotatable elements may include, for example, the rotor shaft or transmission elements such as gears. The components and/or rotatable elements accommodated and supported in the support housing may introduce forces and/or moments into the support housing.

The mounting arrangement further includes a coupling device. The coupling device has a coupling element for converting a torsional moment about a torsional moment axis, which is applied by the drive train to the support housing, into a supporting force acting in a supporting direction. The torsional moment may be, for example, a reaction moment of the generator and/or of the gearbox to a driving torque of the rotor shaft. The torsional moment may also include components in directions other than a direction of rotation of the rotor shaft. The supporting force may have a line of action extending in the supporting direction. The coupling element may be configured to convert the torsional moment about the torsional moment axis into the supporting force acting in the supporting direction with the aid of a geometric arrangement that provides a lever arm between the torsional moment axis and the line of action of the supporting force. The supporting direction may be a direction perpendicular to the torsional moment axis. The supporting direction may also include components that are not perpendicular to the torsional moment axis. For example, in the case of a horizontal-type wind turbine, where the rotor shaft extends substantially horizontally, the supporting direction may be substantially vertical to the ground. In the case of a vertical-type wind turbine, where the rotor shaft extends substantially vertically, the supporting direction may be substantially horizontal, i.e. parallel to the ground.

The mounting arrangement may be configured to support at least the torsional moment of the rotor shaft via the bedplate on the tower with the aid of the coupling element. The wind turbine may be provided with a further mounting arrangement that additionally supports the rotor shaft on the tower. The further mounting arrangement can, for example, absorb radial forces of the rotor shaft. The further mounting arrangement may include, for example, a main rotor shaft bearing disposed near a rotor end of the rotor shaft. The main rotor shaft bearing may be configured to absorb radial forces. The main rotor shaft bearing may also be configured to absorb axial forces of the rotor shaft. The main rotor shaft bearing may also be mounted to the bedplate or may be formed integrally therewith.

The coupling element may be configured as a torque support which transmits the torsional moment to the bedplate at a distance from the torsional moment axis. The coupling element may be configured to support the torsional moment on the bedplate by introducing the supporting force into the bedplate. The coupling element may also be configured to introduce other forces not generated by the torsional moment into the bedplate. For example, the coupling element may be configured to introduce a weight force acting on the support housing into the bedplate. When a force or moment is introduced, this means that a degree of freedom associated with the force or moment is locked. Consequently, introducing a force in a direction means that displacement in the direction is restrained or substantially prevented. Similarly, introducing a moment means that rotation about the moment axis is restrained or substantially prevented.

The coupling element may be attached to the support housing. The coupling element may also be formed integrally with the support housing. The coupling element may be attached to the bedplate. The coupling element may be fixedly or movably attached to the support housing and/or to the bedplate. For example, the coupling element may be attached to the support housing and/or to the bedplate via a pivot joint. As an example, the coupling element may be configured as a rod link or include a rod link. As another example, the coupling element may be formed as a wishbone link or include a wishbone link. The construction of a rod link and that of a wishbone link will be described in detail later.

The coupling device further includes a bearing element for introducing the supporting force from the coupling element into the bedplate. The bearing element may be configured to connect the coupling element to the bedplate. The bearing element may be configured to lock certain kinematic degrees of freedom between the coupling element and the bedplate. The bearing element may be configured, for example, as a sliding bearing. The sliding bearing may, for example, be a flat sliding bearing that allows displacements normal to the supporting direction, but locks displacements in the supporting direction on one or both sides. Alternatively or additionally, the bearing element may include a kinematic mechanism to guide a relative movement between the coupling element and the bedplate with at least one degree of freedom. The bearing element may be damped or undamped. A damped bearing element can counteract an applied force and thus provide resistance to the displacement associated with the force. An undamped bearing element can allow a displacement caused by the applied force to occur substantially without resistance.

The coupling device is configured to allow displacements of the support housing relative to the bedplate in a transverse direction perpendicular to the torsional moment axis and to the supporting direction. The displacements of the support housing relative to the bedplate in the transverse direction may be enabled by the bearing element, by the coupling element, or by a combination of the two. For example, the bearing element may be configured such that it allows displacement in the transverse direction of the coupling element relative to the bedplate. For example, the coupling element may be configured to vary its geometry, for example to deform, in order to allow the relative movement of the support housing with respect to the bedplate.

The mounting arrangement according to the first aspect provides a mounting arrangement that decouples the introduction of forces into the bedplate in the transverse direction from the introduction of forces in other directions and from the introduction of the torsional moment. In principle, components of the drive train that are operatively connected to the rotor and the tower, such as the gearbox, can represent a source of vibration excitation for the rotor and/or the tower and can generate operational vibrations. Vibration excitation occurs, for example, in radial directions of the rotor shaft. In certain cases, the radial directions have components in the supporting direction and in the transverse direction. In view of the large weights of the drive train, this vibration excitation results in significant forces being introduced into the rotor and the tower. The rotor, for example the rotor blades, and/or the tower can serve as resonant bodies and further amplify the vibrations. By decoupling the introduction of forces in the transverse direction according to the first aspect, the vibration excitation in the transverse direction is also decoupled. Since the vibration excitation components in the supporting direction are decoupled from the vibration excitation components in the transverse direction, the mounting arrangement of the first aspect significantly reduces the vibration excitations acting on the bedplate. Even if the transverse forces are introduced into the bedplate via other elements of the mounting arrangement or another mounting arrangement, this can take place in a spatially separated manner, so that vibration modes do not amplify each other, or only to a minor extent. Accordingly, the first aspect provides a mounting arrangement for a wind turbine that minimizes operational vibrations with a simple design.

In one embodiment, the bearing element is configured as a sliding element to enable displacements of the support housing in the transverse direction relative to the bedplate. The bearing element configured as a sliding element may, for example, have two flat sliding surfaces which can slide relative to each other with a component in the transverse direction. The bearing element may be configured to allow displacements of the support housing only in the transverse direction. The bearing element may also be configured to allow displacements in a direction parallel to the torsional moment axis. The bearing element may allow the respective displacements to take place in a damped or undamped manner. The bearing element configured as a sliding element provides a simple design.

In one embodiment, the mounting arrangement has two coupling devices. The two coupling devices are disposed on opposite sides of the torsional moment axis. This makes it possible to further distribute the introduction of forces into the bedplate. For example, the coupling devices may be configured to introduce supporting forces only on one side, that is, only in one direction. Since the coupling devices are disposed on opposite sides of the torsional moment axis, each coupling device may thus support the torsional moment in only one torsional moment direction. Thus, vibrations about the torsional moment axis are also introduced only on one side, which overall allows the vibration excitations to be reduced. In another embodiment, the coupling elements may be configured to introduce the supporting forces on both sides. This allows the coupling elements to be made smaller, since each coupling element only needs to support half of the torsional moment.

In one embodiment, the mounting arrangement includes a further coupling element for transmitting forces in the transverse direction from the support housing to the bedplate. The further coupling element may be configured in the same way as the coupling element or may be different from it. The further coupling element may be configured to introduce forces in the transverse direction into the bedplate at a different attachment point than the coupling element. The further coupling element may be configured to prevent or dampen displacements in the transverse direction. The further coupling element may be disposed at the same level along the torsional moment axis as the bearing element of the coupling element. Alternatively, the further coupling element may be disposed at a different level along the torsional moment axis than the bearing elements.

In one embodiment, the bearing element is configured to absorb forces in the direction of the torsional moment axis. This allows the coupling device to also introduce forces in the direction of the torsional moment axis into the bedplate. The forces in the direction of the torsional moment axis may have at least components in the axial direction of the axis of rotation, so that these components are supported. If the bearing element has a lever arm relative to the yaw axis, it is also possible to support a yaw moment about the yaw axis.

In one embodiment, the bedplate is mounted on the tower such that it is rotatable about a yaw axis. The bearing element is configured to allow displacements in a circumferential direction about the yaw axis. The mounting arrangement includes a further coupling element for converting a yaw moment about the yaw axis on the support housing into a force in the transverse direction. The further coupling element for converting the yaw moment is configured to introduce the force in the transverse direction into the bedplate. The further coupling element for converting the yaw moment may be configured in the same way as the coupling element or may be different from it. The further coupling element for converting the yaw moment may be the further coupling element for transmitting forces in the transverse direction or may be different from it. The mounting arrangement may include a plurality of further coupling elements.

In one embodiment, one of the coupling elements includes a rod link. The rod link is configured to transmit tensile and compressive forces. The rod link is rotatably mounted at both of its ends. The coupling element including a rod link may be one, several, or all of the coupling elements and/or of the further coupling elements. The rod link may be configured to provide a kinematic coupling between the two ends thereof. The rod link may have a greater rigidity in a longitudinal direction between its ends than transverse to the longitudinal direction. The rod link may be configured to transmit tensile and compressive forces in the longitudinal direction. The ends of the rod link may be rotatably mounted by a rotatable joint. Examples of rotatable joints include a pivot joint with one rotational degree of freedom, a universal or homokinetic joint with two rotational degrees of freedom, and a ball joint with three rotational degrees of freedom. The use of a rod link provides simple guidance and introduction of forces. The use of rotatable joints at the ends of the rod link prevents unwanted coupling to degrees of freedom other than the displacement in the longitudinal direction of the rod link.

The rod link may be made of a metallic or a non-metallic material. The rod link may have passive or active damping means. The rod link may be configured to allow for a change in length of the rod link. The changes in length may be produced by deformation of the rod link. Alternatively or additionally, the change in length may be produced by relative displacement of two parts of the rod link. The change in length may serve, for example, to enable displacement of the support housing in the transverse direction. The rod link may be configured as an actuator for actively causing a change in length. By actively causing a change in length of a rod link, it is possible to cause a desired change in a position. If, for example, a further coupling element that supports a yaw moment includes a rod link configured as an actuator, then the change in length of the rod link configured as an actuator can be used to cause a yaw movement.

In one embodiment, one of the coupling elements is configured as a wishbone link. The coupling element configured as a wishbone link may be one, several, or all of the coupling elements and/or of the further coupling elements. The wishbone link may be configured to provide a kinematic coupling between three attachment points. The wishbone link may, for example, be L-shaped or triangular. The wishbone link may include fixed elements and/or articulatedly mounted elements, for example rod links, as described above, for kinematic coupling between the attachment points. The wishbone link may have the shape of a triangle. Two legs of the triangle may be configured as force-transmitting element, for example, as a rod link. The legs may be angled relative to each other and converge at a vertex of an angle. As a third leg, the triangle may include a portion of a component that connects the ends of the legs distal from the vertex of the angle. Examples of such an end-connecting component may include portions of the support housing, of the bedplate, and/or of an auxiliary frame described later. As an example of a wishbone link, two elongated components, for example rotatably or fixedly mounted rod links, may be attached at different levels to the support housing and converge toward the bearing element, so that a portion of the support housing forms a triangle with the elongated components. As a further example, two rod links may diverge from the support housing toward respective bearing elements, two bearing elements being provided at different levels, so that a triangle is formed with the rod links and a connecting part between the two bearing elements.

In one embodiment, one of the coupling elements includes a damping element. The damping element may be passive or active. The damping element may be configured to dampen vibration excitation in the longitudinal direction of the coupling element.

In one embodiment, a plurality of bearing elements and/or coupling elements are attached to an auxiliary frame. The auxiliary frame is mounted on the bedplate. The mounting of the auxiliary frame on the bedplate may be configured to lock all degrees of freedom of the auxiliary frame relative to the bedplate. The mounting may be rigid or may be via joints. Furthermore, the mounting may include damping elements. For example, the auxiliary frame may be mounted to the bedplate via an elastic bearing element. The elastic bearing element may be configured as an elastomeric mount, for example, a rubber damper.

In one embodiment, the support housing and the coupling element are formed separately and from different materials. The support housing is, for example, made of a metallic material, for example, a steel alloy or an aluminum alloy. The coupling element is, for example, made of a non-metallic material.

A second aspect of the present disclosure relates to a wind turbine that includes the mounting arrangement according to the first aspect. The wind turbine may be configured, for example, to generate electricity. The wind turbine includes a drive train, a tower, and the mounting arrangement of the first aspect. The mounting arrangement is mounted on a top of the tower. For example, a bedplate of the mounting arrangement may be mounted on the top of the tower via a yaw bearing. Embodiments of the first aspect also form embodiments of the second inventive aspect and vice versa.

In one embodiment, a bearing element of the mounting arrangement overlaps a top-end wall of the tower in the supporting direction. As a result, the supporting forces are introduced into the tower over a short distance and with high rigidity. Thus, the vibration response of the tower is improved with a simple design.

In one embodiment, the drive train includes a rotor having at least two rotor blades and a generator. The rotor is mechanically operatively connected to the generator via the rotor shaft. In one embodiment, the drive train includes a gearbox which is disposed in a torque flow between the rotor shaft and the generator.

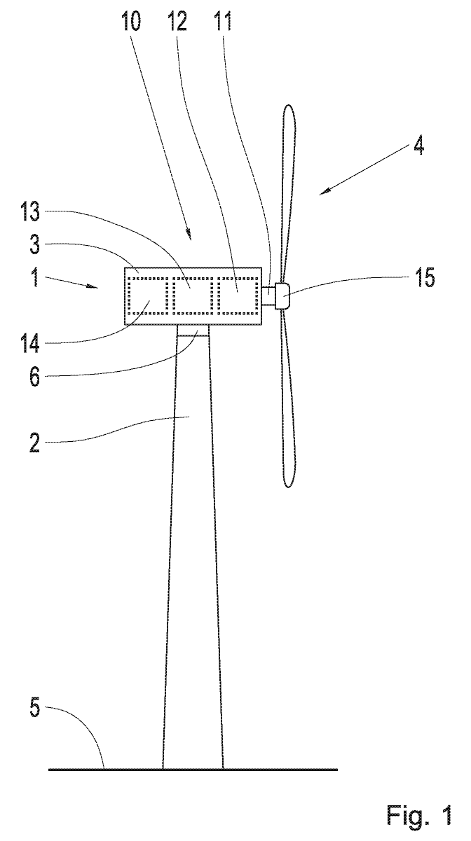

FIG. 1 schematic illustrates a horizontal-type wind turbine 1. Wind turbine 1 includes a nacelle 3, which is rotatably mounted to a top end of a tower 2 via a yaw bearing 6. A bottom end of tower 2 is anchored to a ground 5. Nacelle 3 accommodates a drive train 10 including a rotor shaft 11, a gearbox 12, a generator 13, ancillary equipment 14, and a hub 15. A rotor 4 of wind turbine 1 is mechanically operatively connected to generator 13 via hub 15, rotor shaft 11, and gearbox 12. Ancillary equipment 14 may include devices for controlling the temperature of drive train 10, devices for converting electrical power, devices for adjusting hub 15, and devices for aligning nacelle 3 via yaw bearing 6. Wind turbine 1 further includes a mounting arrangement for supporting portions of a drive train 10.

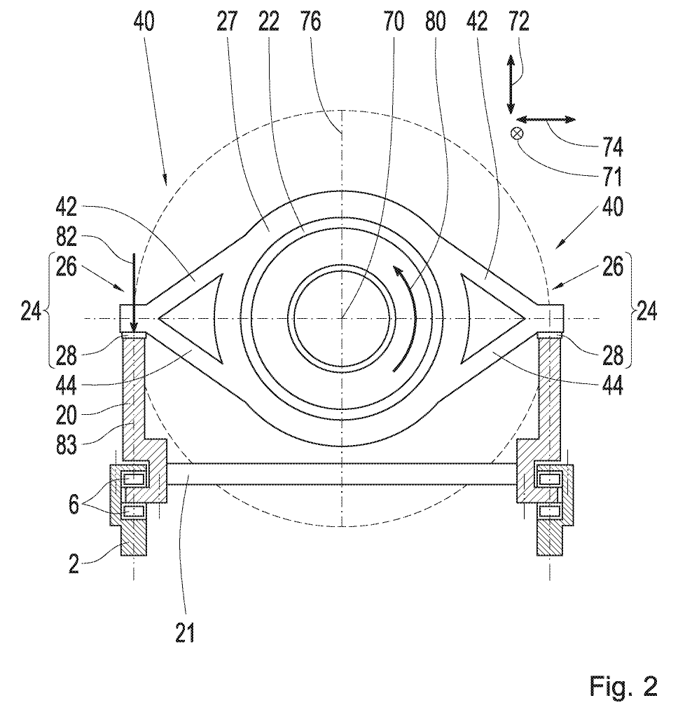

FIG. 2 schematically illustrates, in sectional front view, a first embodiment of a mounting arrangement for drive train 10 of wind turbine 1. The mounting arrangement includes a bedplate 20, here in the form of an annular component. Bedplate 20 is rotatably coupled to tower 2 via yaw bearing 6. A bottom plate 21 is provided at a bottom end within bedplate 20.

The mounting arrangement includes a support housing 22. In the present case, support housing 22 encloses portions of drive train 10 and is rigidly connected to at least one of gearbox 12 and generator 13. Consequently, gearbox 12 and/or generator 13 can transmit reaction forces via rotor shaft 11 to support housing 22 in response to the introduction of forces. It should be noted that further reaction forces introduced via rotor shaft 11, such as radial forces, can be supported on a main rotor shaft bearing (not shown), which functions as a further mounting arrangement.

In the present case, the mounting arrangement includes two coupling devices 24. Each coupling device 24 includes a coupling element 26 and a bearing element 28. In the present embodiment, two coupling devices 24, each including a coupling element 26 and a bearing element 28, are disposed on opposite sides of a torsional moment axis 70. Torsional moment axis 70 substantially corresponds to the axis of rotation of rotor shaft 11. In FIG. 2, torsional moment axis 70 is indicated by a cross within support housing 22. The two coupling devices 24 are identical in design and are merely mirrored horizontally about torsional moment axis 70. Therefore, in order to simplify the description, only one of the coupling devices 24 will described below, namely the left one in FIG. 2. The relationships apply analogously to the right coupling device 24 in FIG. 2, when the direction of a torsional moment 80 described later is reversed.

In the present case, coupling device 24 has a housing connection 27 which at least partially encloses support housing 22 and is coupled thereto in order to absorb all reaction forces from support housing 22. In the present case, coupling element 26 of coupling device 24 is configured as a wishbone link 40. Wishbone link 40 has a triangular shape formed by a portion of housing connection 27 and by two legs 42, 44. In the present case, legs 42, 44 are configured as rigid straight arms which are spaced apart on the side of housing connection 27 and converge toward bearing element 28.

Coupling element 26 of coupling device 24 is configured to convert the torsional moment 80 about torsional moment axis 70 into a supporting force 82 acting in a supporting direction 72. Accordingly, coupling element 26 is functionally configured as torque support. Supporting force 82 is introduced into bedplate 20 via bearing element 28. Supporting force 82 is indicated by an arrow on the left in FIG. 2; a line of action 83 of supporting force 82 is indicated by a dash-double-dot line. In the present case, bearing element 28 is configured to allow displacements of coupling element 26 and thus of support housing 22 in a transverse direction 74 relative to bedplate 20. Transverse direction 74 is perpendicular to both torsional moment axis 70 and supporting direction 72. A direction 71 of torsional moment axis 70, supporting direction 72, and transverse direction 74 are indicated as directional arrows at the top right in FIG. 2. In the present case, bearing element 28 is configured as a flat sliding element that transmits forces in supporting direction 72 and forces in the direction of torsional moment axis 70, but does not transmit forces in transverse direction 74. In the present case, forces in supporting direction 72 are transmitted by bearing element 28 only on one side, namely downwardly.

Torsional moment 80 is applied by the drive train to support housing 22. In the present case, support housing 22 is mechanically coupled to housing connection 27. Due to the configuration of coupling element 26, bearing element 28 is spaced apart from torsional moment axis 70. Therefore, coupling element 26 serves as a lever arm for the torsional moment 80 applied to support housing 22. This lever arm converts torsional moment 80 into supporting force 82, which is introduced into bedplate 20 via bearing element 28. Further, in the present embodiment, bearing element 28 is spaced from a yaw axis 76 and is also configured to absorb forces in the direction of torsional moment axis 70, which substantially corresponds to a circumferential direction about yaw axis 76 in the cross-sectional plane of FIG. 2. Thus, in the present embodiment, bearing element 28 is also able to support a yaw moment about yaw axis 76. In contrast, displacements in transverse direction 74 are permitted by bearing element 28, so that vibrations and forces in transverse direction 74 are not introduced into bedplate 20.

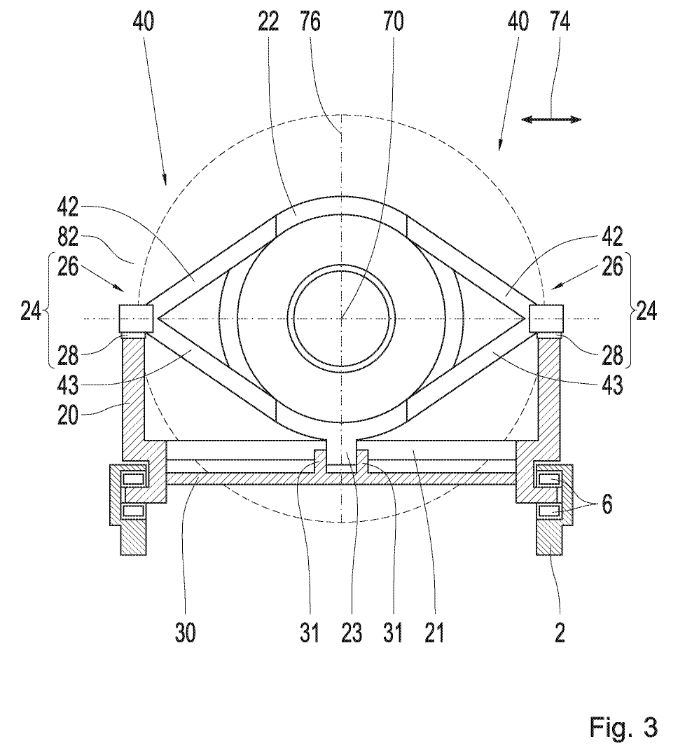

FIG. 3 schematically illustrates, in sectional front view, a second embodiment of a mounting arrangement for drive train 10 of wind turbine 1. Only differences from the first embodiment of FIG. 2 will be described. In the second embodiment, bearing element 28 is configured to allow displacements in the circumferential direction about yaw axis 76. Thus, the bearing element 28 of the second embodiment is not configured to support the yaw moment about yaw axis 76. In order to support the yaw moment about yaw axis 76, a further coupling element 30 is provided in the second embodiment. In the present case, further coupling element 30 is configured as a rigid transverse member. Further coupling element 30 is attached to bedplate 20 and extends in transverse direction 74. Further coupling element 30 is offset with respect to yaw axis 76 along torsional moment axis 70 and thus is spaced from yaw axis 76. Further coupling element 30 has two connecting portions 31 which are associated with a connecting element 23. Connecting element 23 is fixedly connected to support housing 22 for the introduction of forces. Connecting element 23 and connecting portions 31 are configured to transmit forces in transverse direction 74. Since further coupling element 30 is spaced from yaw axis 76, its attachment to support housing 22 via connection portions 31 and connecting element 23 converts a yaw moment acting on support housing 22 about yaw axis 76 into a transverse force 84 that is introduced into further coupling element 30. Since further coupling element 30 is attached to the bedplate 20, the mounting arrangement of the second embodiment is capable of supporting the yaw moment about yaw axis 76 separately from the supporting of torsion moment 80.

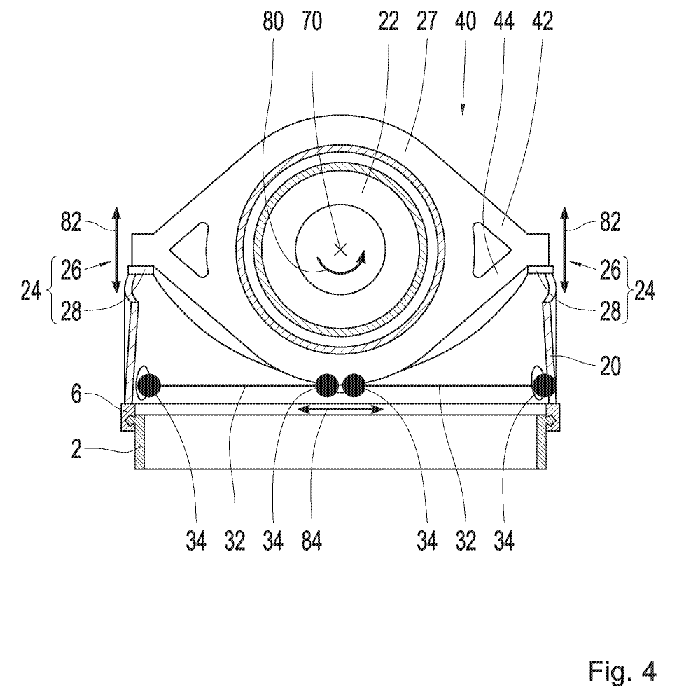

FIG. 4 schematically illustrates, in sectional front view, a third embodiment of a mounting arrangement for drive train 10 of wind turbine 1. Only differences from the second embodiment will be described. While in the second embodiment, transverse forces are transmitted by a rigid further coupling element 30, in the third embodiment, transverse forces are transmitted via two further coupling elements 32. Further coupling elements 32 are each configured as a rod link. Each further coupling element 32 configured as a rod link has a joint 34 at each of its two ends. Joints 34 are configured as ball joints, which have all rotations as free degrees of freedom. Further coupling elements 32 extend approximately parallel to transverse direction 84. In addition, further coupling elements 32 are spaced from yaw axis 70. Thus, further coupling elements 32 are capable of supporting transverse forces and yaw moments of drive train 10 and of support housing 22.

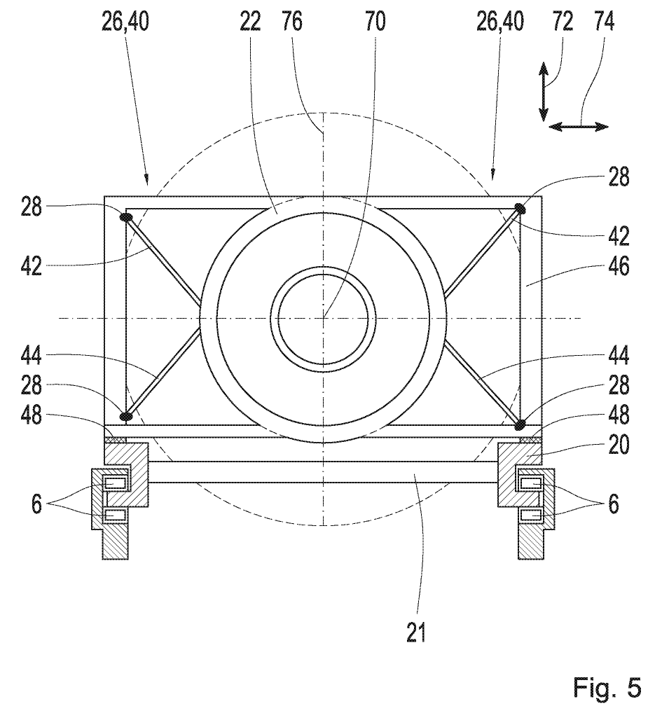

FIG. 5 schematically illustrates, in sectional front view, a fourth embodiment of a mounting arrangement for drive train 10 of wind turbine 1. Only differences from the first embodiment of FIG. 2 will be described. In comparison with the coupling elements 26 of the first embodiment, the coupling elements 26 of the fourth embodiment, are not mounted directly on bedplate 20, but on an auxiliary frame 46. Auxiliary frame 46 is supported on bedplate 20 via an elastic bearing elements 48. Elastic bearing elements 48 allow slight movements of auxiliary frame 46 in the directions perpendicular to supporting direction 72 and have a high degree of damping. Support housing 22 is mounted in auxiliary frame 46 via two coupling elements 26. In the present case, coupling elements 26 are configured as wishbone links 40. Each wishbone link 40 is formed by two legs 42, 44 and by a portion of auxiliary frame 46. Legs 42, 44 are mounted on the frame 46 via respective bearing elements 28. At their other end, legs 42, 44 are rigidly connected to support housing 22. In the present case, legs 42, 44 are configured as rod links which allow displacements of support housing 22 in transverse direction 74. More specifically, legs 42, 44 are capable of changing their length under the action of forces in transverse direction 74. In the present case, this change in length is passively damped by the structure of legs 42, 44. In a further embodiment, legs 42, 44 have active damping structures. In the fourth embodiment, the aforedescribed structure of the wishbone links 40 of coupling elements 26 provides substantially a double wishbone structure. This allows torsional moment 80 to be absorbed with high rigidity, while displacements of support housing 22 in the transverse direction relative to auxiliary frame 46 and bedplate 20 are made possible. These displacements are strongly dampened by legs 42, 44. In addition, frame 46 is supported on bedplate 20 via elastic bearing elements 48. From all of the above, it is apparent that the mounting arrangement of the fourth embodiment has vibrational properties.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMERALS

1 wind turbine

2 tower

3 nacelle

4 rotor

5 ground

6 yaw bearing

10 drive train

11 rotor shaft

12 gearbox

13 generator

14 ancillary equipment

15 hub

20 bedplate

21 bottom plate

22 support housing

23 connecting element

24 coupling device

26 coupling element

27 housing connection

28 bearing element

30, 32 further coupling element

31 connecting portion

34 joint

40 wishbone link

42, 44 leg

46 auxiliary frame

48 elastic bearing element

70 torsional moment axis

71 direction of the torsional moment axis

72 supporting direction

74 transverse direction

76 yaw axis

80 torsional moment

82 supporting force

83 line of action

84 transverse force

What is claimed is:

1. A mounting arrangement for a wind turbine for supporting a drive train on a tower of the wind turbine, the mounting arrangement comprising:
a bedplate that is mounted on the tower;
a support housing for accommodating and supporting the drive train; and
a coupling device including a coupling element for converting a torsional moment about a torsional moment axis, which is applied by the drive train to the support housing, into a supporting force acting in a supporting direction, wherein the coupling device further includes a bearing element for introducing the supporting force from the coupling element into the bedplate, the coupling device being configured to allow displacements of the support housing relative to the bedplate in a transverse direction perpendicular to the torsional moment axis and to the supporting direction.

2. The mounting arrangement as recited in claim 1,
wherein the bearing element is configured as a sliding element to enable displacements of the support housing in the transverse direction relative to the bedplate.

3. The mounting arrangement as recited in claim 1,
wherein the mounting arrangement has two coupling devices disposed on opposite sides of the torsional moment axis.

4. The mounting arrangement as recited in claim 1,
wherein the mounting arrangement includes a further coupling element for transmitting forces in the transverse direction from the support housing to the bedplate.

5. The mounting arrangement as recited in claim 1,
wherein the bearing element is configured to absorb forces in a direction of the torsional moment axis.

6. The mounting arrangement as recited in claim 1;
wherein the bedplate is mounted on the tower such that it is rotatable about a yaw axis, the bearing element is configured to allow displacements in a circumferential direction about the yaw axis, and the mounting arrangement includes a further coupling element for converting a yaw moment about the yaw axis on the support housing into a force in the transverse direction, and the further coupling element for converting the yaw moment is further configured to introduce the force in the transverse direction into the bedplate.

7. The mounting arrangement as recited in claim 1,
wherein the coupling element includes a rod link which is configured to transmit tensile and compressive forces and which is rotatably mounted at both of its ends.

8. The mounting arrangement as recited in claim 1,
wherein the coupling element is configured as a wishbone link.

9. The mounting arrangement as recited in claim 8,
wherein the coupling element includes a damping element.

10. A wind turbine comprising a drive train, a tower, and the mounting arrangement according to claim 1 which mounting arrangement is mounted on a top of the tower.

11. The wind turbine as recited in claim 10, wherein a bearing element of the mounting arrangement overlaps a top-end wall of the tower in the supporting direction.
